(19) United States
(12) Patent Application Publication
(10) Pub. No.: US 2011/0181385 A1
(43) Pub. Date: Jul. 28, 2011

(54) THERMAL FUSE

(75) Inventors: Georg Schulze-Icking-Konert, Buehlertal (DE); Daniel Seebacher, Forchheim (DE)

(73) Assignee: Robert Bosch GmbH, Stuttgart (DE)

(21) Appl. No.: 13/003,708

(22) PCT Filed: Jun. 12, 2009
(86) PCT No.: PCT/EP2009/057255

§ 371 Date: Mar. 25, 2011

(30) Foreign Application Priority Data
Jul. 11, 2008 (DE) 10 2008 040 345.8

(51) Int. Cl. H01H 85/05

(52) U.S. Cl. 337/290

(57) ABSTRACT

The invention relates to a thermal fuse (1) for interrupting a power flow in modules, particularly for use in the automotive field, comprising: - a connecting element having a connecting region, - a fusible element (3) composed of fusible material and attached with one end to the connecting region (2) in order to establish an electrically conductive connection between the fusible element (3) and the connecting element (2), the connecting element (2) comprising an expansion region for accommodating melted fusible material, characterized in that the expansion region has an expansion surface (6) on which part of or all of the melted fusible material spreads as the fusible element melts, the expansion surface (6) having no positive curvature.

### BACKGROUND OF THE INVENTION

The invention relates to a thermal fuse for interrupting a power flow in modules, in particular for use in the automotive field.

In order to protect electric modules against overheating, irreversible thermal fuses are required which, at an excessively high ambient temperature, interrupt a power-conducting conductor, that is to say trigger the fuse. The thermal fuses are configured here in such a way that the triggering temperature is not reached as a result of a high power flow, so that it is ensured that said thermal fuses cannot be triggered by a high current but rather only by an excessively high ambient temperature. A thermal fuse of the abovementioned type therefore serves to make available an independent switch-off path for electric modules, wherein the power flow is reliably interrupted when there are unacceptably high temperatures in the module, for example owing to failures of components, short-circuits, for example due to an extraneous effect, malfunctions of insulating materials and the like.

Conventional thermal fuses are usually based on the concept of a secured spring, for example a soldered-in leaf spring, which, in the case of triggering, opens a contact by means of a spring force. In this context, even in the non-triggered case, a mechanical force is continuously applied to the connecting point, which can lead to quality problems, specifically in the case of long periods of use such as, for example, the long operating times in the automotive field. In particular, the soldering point may shatter after some time.

An alternative embodiment of a thermal fuse uses a conductive fusible element composed of a fusible material which begins to melt at a triggering temperature and as a result interrupts an electrical connection. Such a fusible element is generally arranged between two connecting regions at which the molten material of the fusible element collects after the melting owing to the surface tension. Disconnection has been successful if a coating or a droplet of fusible material has formed at one connecting region or at both connecting regions without a conductive bridge of fusible material remaining between the connecting regions.

In trials with connecting regions whose end side, on which the fusible element bears completely, is just as large as the cross section of the bearing surface of the fusible element or, in the case of beaker-shaped connecting regions, which completely encloses the fusible element at its ends, it has been observed that said fusible elements do not always trigger reliably since a conductive bridge of fusible material remains between the coverings or between the droplets at the connecting regions.

### SUMMARY OF THE INVENTION

The object of the present invention is therefore to make available a thermal fuse of the abovementioned type which triggers more reliably.

According to one aspect, a thermal fuse is provided for interrupting a power flow in modules, in particular for use in the automotive field. The thermal fuse comprises a connecting element with a connecting region, and a fusible element composed of fusible material and attached by one end to the connecting region in order to provide an electrically conductive connection between the fusible element and the connecting element. The connecting element has an expansion region for accommodating molten fusible material. The expansion region has an expansion surface on which part or all of the molten fusible material spreads as the fusible element melts, wherein the expansion surface does not have a positive curvature.

One concept of the above thermal fuse is to construct the expansion regions for accommodating the molten fusible material in such a way that, when triggering occurs, the separation of the current path by the fusible element is assisted by use of the surface tension of the molten fusible material. In particular, the connecting elements in the expansion region have a surface structure in which, in particular, an energy barrier to the expansion of the molten fusible material is avoided. This can be achieved, in particular, by virtue of the fact that the expansion surface is provided only with curvatures of 0 or with positive curvatures, and in particular negative curvatures are avoided in order to reduce the surface energy. It is therefore possible to minimize the risk of bridges composed of fusible material remaining between the connecting regions of the thermal fuse.

Furthermore, the thermal fuse can have two connecting elements, between which connecting elements which the fusible element is accommodated, with the result that ends of the fusible element are attached to the corresponding connecting elements.

According to one embodiment, the expansion surface can be a planar surface. In particular, the expansion surface can run essentially perpendicularly with respect to the direction in which the fusible element bears against the connecting element.

According to a further embodiment, the expansion surface can correspond to an internal surface of a beaker-shaped structure which has an internal diameter which is larger than the cross section of the fusible element within the beaker-shaped structure. In particular, the volume of the beaker-shaped structure can correspond to at least half the volume of the fusible material of the fusible element.

Furthermore, a base surface of the beaker-shaped structure can be larger than the cross-sectional area of the end of the fusible element.

According to a further embodiment, the expansion surface can correspond to an internal surface of a funnel-shaped structure. In particular, the tip of the funnel-shaped structure can be flattened with a surface which is equal to or smaller than the cross-sectional area of the end of the fusible element.

Furthermore, the expansion surface of an internal surface can comprise a hollow cone structure whose internal diameter at one point is larger than the diameter of the fusible element.

### BRIEF DESCRIPTION OF THE DRAWINGS

Preferred embodiments are explained in more detail with reference to the appended drawings in which:

FIGS. 1a and 1b show a conventional thermal fuse in the non-triggered and in the triggered state;

FIG. 2 shows a conventional thermal fuse with beaker-shaped connecting regions;

FIGS. 3a and 3b show a thermal fuse with expanded connecting regions in a non-triggered and triggered state;

FIGS. 4 and 4b show a further thermal fuse in a non-triggered and triggered state; and

FIGS. 5a and 5b show a further thermal fuse in a non-triggered and triggered state.

### DETAILED DESCRIPTION

In the following description, identical reference symbols denote elements with an identical or comparable function.

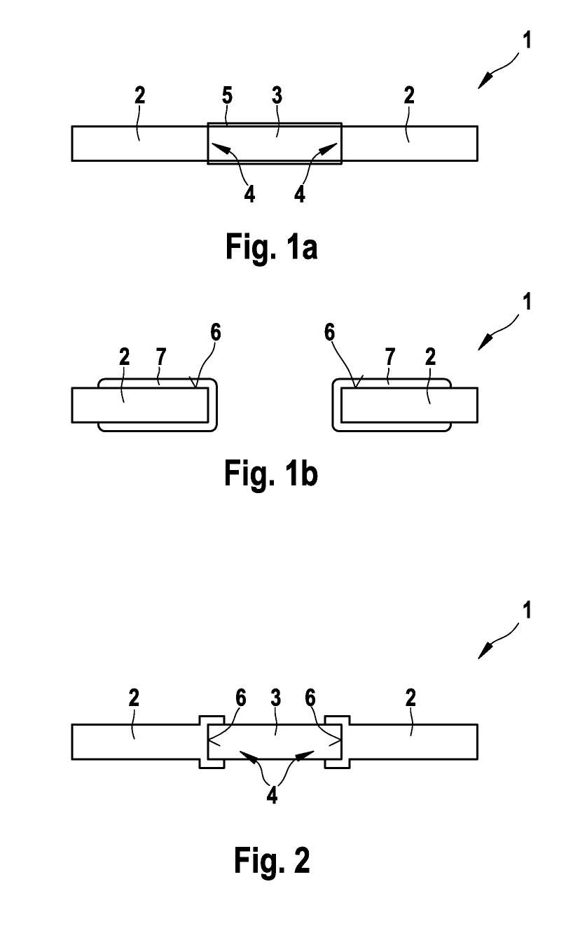

FIGS. 1a and 1b illustrate a conventional thermal fuse 1 which has two connecting elements 2 between which a conductive fusible element 3 is arranged. The fusible element 3 is fastened, for example soldered, by its two ends to a respective connecting region 4 of the connecting lines 2. The cross section of the connecting elements 2 at the contact site with the fusible element 3 and the cross section at the ends of the fusible element 3 are essentially identical, with the result that the connecting elements 2 merge, with respect to their surfaces, essentially flush with the fusible element 3.

If the ambient temperature of the thermal fuse 1 exceeds a threshold value, the fusible material of the fusible element 3 melts. The fusible material of the fusible element is preferably a metal or an alloy such as, for example solder, which has a low melting point which in the molten state has a high surface energy, i.e. surface tension. A fluxing agent 5 can be provided on the surface or in the interior of the fusible element 3, which fluxing agent 5 penetrates the oxide skin during the melting and increases the wetting or the surface tension.

Owing to the surface tension of the molten fusible material, the liquid fusible material creeps out over the connecting region 4 of the connecting elements 2 over an expansion surface 6 of the connecting elements 2 in which the connecting region 4 is located. As a result, additional fusible material is distributed on the previously exposed surface of the connecting element 2, with the result that the liquid fusible material is drawn out of the center of the fusible element 3 which previously formed the conductive connection between the connecting elements 2. This occurs until the fusible element 3 is completely divided into two parts of fusible material on the connecting elements 2, which parts collect as droplets or covering on the respective expansion surface 6 of the connecting element 2. As a result, the conductive connection between the connecting elements 2 will be interrupted.

In trials with such thermal fuses it has been found that they do not always reliably trigger since despite melting of the fusible material conductive bridges of fusible material remain between the connecting elements 2. A reason for this is clearly that the surface tension of the fusible material is too low, that is to say the affinity of the molten fusible material to become distributed on the available expansion surface 6 of the connecting element 2, i.e. in an expansion region, is not sufficient to completely separate the fusible material between the connecting elements 2.

An analysis of the free surface energy is useful to understand this phenomenon. The surface tension corresponds to the different between the free surface energies of the surface of the connecting element 2 and the surface of the liquid fusible material. According to the general Gibbs Thomsen relation, the surface energy is composed of a constant, material-dependent portion and a portion which depends on the curvature of the surface on which the molten material is to be distributed:

E=E₀+E₁/rₖ,

where E corresponds to the entire surface energy, E₀ corresponds to a portion of the constant material-dependent surface energy, and E₁/rₖ corresponds to a portion of the curvature-dependent surface energy (where rₖ=the curvature radius).

Since the curvature radius rₖ=∞ during the formation of the thermal fuse according to FIGS. 1 and 1b, the curvature-dependent surface energy equals E₁rₖ=0.

In the thermal fuse 1 in FIG. 2 with a beaker-shaped connecting region 4 of the connecting element 2, which connecting region 4 completely surrounds the fusible element 3 at its ends, the curvature-dependent portion of the free surface energy is even positive since the edge of the beaker-shaped connecting region 4 comprises positive curvatures. These positive curvatures constitute energy barriers which counteract spreading of the molten fusible material over the expansion region 6 on the connecting elements 2 and therefore increases the risk that too little material is drawn onto the expansion surface 6 or surface of the connecting elements 2 and as a result a conductive bridge of fusible material remains between the connecting elements 2.

By means of a suitable selection of the geometry of the expansion region 6 of one or more of the connecting elements 2 it is now possible to ensure that the curvature-dependent portion of the surface energy is negative during and after the triggering and the drawing together of the molten fusible material parts 7 at the connecting regions is therefore assisted.

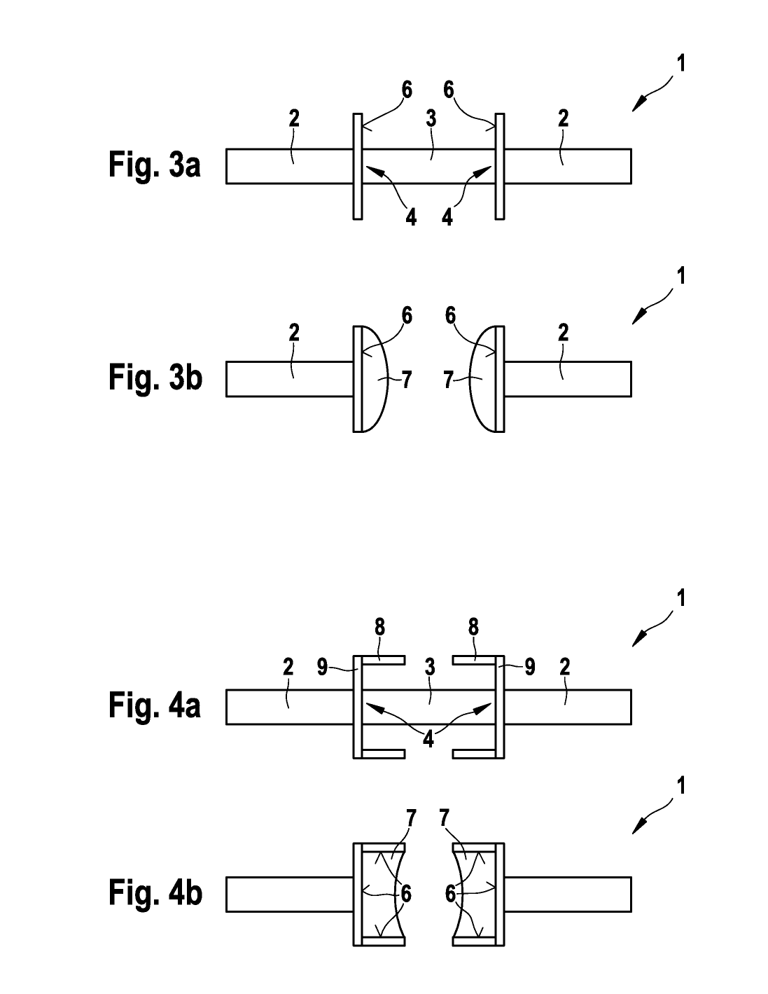

FIGS. 3a and 3b, 4a and 4b as well as 5a and 5b show embodiments of the thermal fuses 1 which do not provide any, or only provide a negative curvature, to the molten fusible material parts 7 within the corresponding expansion region 6 even after the melting process. The free surface energy is therefore reduced, as a result of which spreading of the molten fusible material is assisted. This reduces the risk of bridges of fusible material remaining between the connecting elements 2.

In the embodiment in FIGS. 3a and 3b, an expansion region 6 is embodied as a surface section of the connecting element 2. The expansion region 6 comprises a planar surface which contains the connecting region 4 of the connecting element 2. In other words, the surface of the connecting region 4 is widened, with the result that the surface of the connecting region 4 on which the fusible element 3 bears before the melting process and the expansion surface 6 on which the molten fusible material spreads lie in a planar surface.

The expansion surface 6 is preferably embodied with a size which is sufficient to accommodate a quantity of molten fusible material which ensures that no conductive bridge remains between the connecting elements 2. The entire surface depends, inter alia, on the surface tension of the fusible material (material properties) and the volume of the fusible element 3. However, the surface is preferably selected to be of such a size that there is room for a droplet of half the quantity of the fusible material of the fusible element 3 on the planar expansion surface 6 of the connecting element 2. This may be determined empirically, for example.

In the embodiment in FIGS. 4a and 4b, the expansion surfaces 6 are embodied in a beaker shape with a beaker edge 8 and a beaker base 9. The beaker base 9 is preferably planar and has a larger surface than would correspond to the connecting region 4 of the fusible element 3. The beaker edges 8 of the expansion surface 6 protrude perpendicularly or obliquely inwards or outwards from the beaker base 9 in the direction of the connecting element 2 lying opposite or in the direction of the fusible element 3. The angle between the beaker base 9 and the beaker edge 8 forms a negative curvature which assists the distribution or spreading of the molten fusible material over the beaker-shaped expansion surface 6.

The volume of the beaker-shaped expansion surface 6, that is to say the volume which is defined by the edge of the beaker edge 8 lying opposite the beaker base 9, is of a size to accommodate the volume of the molten fusible material part 7 which corresponds at least to half the volume of the fusible material of the fusible element 3. FIG. 4b illustrates a distribution of the molten fusible material on the beaker-shaped expansion surface 6.

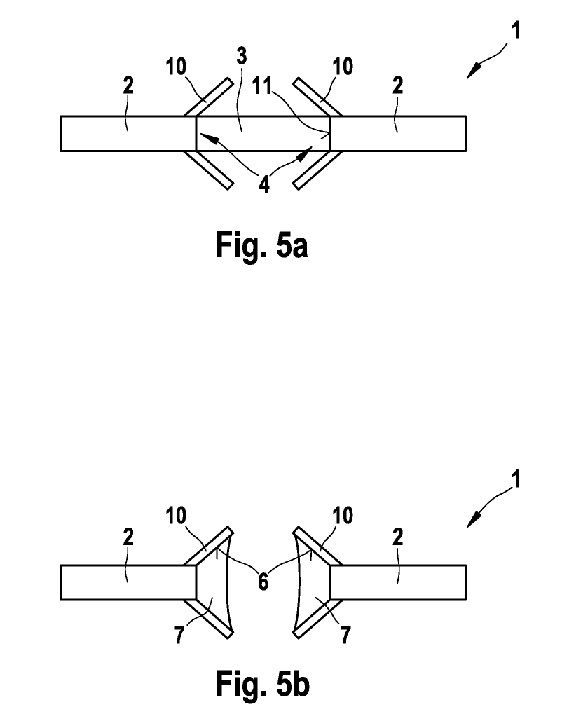

FIGS. 5a and 5b illustrate a further thermal fuse 1 in which the expansion surface 6 is embodied in the shape of a funnel. The thermal fuse 1 in FIG. 5 has for this purpose a connecting funnel 10 as an expansion region which is arranged around the surface 11 of the connecting region 4 of the connecting element 2. Between the surface 11 and the funnel-shaped expansion region 10 there is also a negative curvature which assists the distribution and expansion of the molten fusible material within the connecting funnel 10. As in the embodiment in FIGS. 4a and 4b, there is provision that the volume which is formed by the connecting funnel 10 corresponds at least to half the volume of the fusible material of the fusible element 3.

In all the embodiments the fusible material can be formed from solder which has a low melting point and which is preferably provided with a fluxing agent such as, for example, a fluxing agent core in the interior of the fusible element 3 or is embodied as a surface covering of the fusible element 3.

Other embodiments such as, for example, a hollow cone which is opened toward the connecting region lying opposite and whose internal surface also has a negative curvature may also be provided. The size of the region in which the molten fusible material is distributed depends on the volume of the fusible element and the fusible material part which accumulates on the respective connecting element 3. It should be the case that the boundary of the expansion region must not be exceeded by the molten fusible material as the fusible element 3 melts, so that the thermal fuse 1 is completely separated.

In the embodiment shown, the connecting elements 2 lying opposite one another are embodiment in an identical way. They may also be embodied in different ways, as a result of which, in particular, the distribution of the fusible material parts which accumulate during the melting process can be displaced e fusible element (3).

1. A thermal fuse (1) for interrupting a power flow in modules, comprising:
a connecting element (2) with a connecting region, and
a fusible element (3) composed of fusible material and attached by an end to the connecting region in order to provide an electrically conductive connection between the fusible element (3) and the connecting element (2);
wherein the connecting element (2) has an expansion region for accommodating molten fusible material, characterized in that the expansion region has an expansion surface (6) on which at least part of the molten fusible material spreads as the fusible element melts, wherein the expansion region (6) does not have a positive curvature.

2. The thermal fuse (1) as claimed in claim 1, characterized in that two connecting elements (2) are provided, between which connecting elements (2) the fusible element (3) is accommodated, and ends of the fusible element (3) are attached to the corresponding connecting elements (2).

3. The thermal fuse (1) as claimed in claim 1, characterized in that the expansion surface (6) is a planar surface.

4. The thermal fuse (1) as claimed in claim 3, characterized in that the expansion surface (6) runs essentially perpendicularly with respect to a direction in which the fusible element (3) bears against the connecting element.

5. The thermal fuse (1) as claimed in claim 1, characterized in that the expansion surface corresponds to an internal surface of a beaker-shaped structure which has an internal diameter which is larger than a cross section of the fusible element (3) within the beaker-shaped structure.

6. The thermal fuse (1) as claimed in claim 5, characterized in that a volume of the beaker-shaped structure corresponds to at least half a volume of the fusible material of the fusible element (3).

7. The thermal fuse (1) as claimed in claim 5, characterized in that a base surface (9) of the beaker-shaped structure is larger than a cross-sectional area of the end of the fusible element (3).

8. The thermal fuse (1) as claimed in claim 1, characterized in that the expansion surface (6) corresponds to an internal surface of a funnel-shaped structure.

9. The thermal fuse (1) as claimed in claim 8, characterized in that a tip of the funnel-shaped structure is flattened with a surface which is equal to or smaller than a cross-sectional area of the end of the fusible element (3).

10. The thermal fuse (1) as claimed in claim 1, characterized in that the expansion surface (6) corresponds to an internal surface of a hollow cone structure whose internal diameter at one point is larger than a diameter of the fusible element (3).

11. The thermal fuse (1) as claimed in claim 2, characterized in that the expansion surface (6) is a planar surface.

12. The thermal fuse (1) as claimed in claim 11, characterized in that the expansion surface (6) runs essentially perpendicularly with respect to a direction in which the fusible element (3) bears against the connecting element.

13. The thermal fuse (1) as claimed in claim 2, characterized in that the expansion surface corresponds to an internal surface of a beaker-shaped structure which has an internal diameter which is larger than a cross section of the fusible element (3) within the beaker-shaped structure.

14. The thermal fuse (1) as claimed in claim 13, characterized in that a volume of the beaker-shaped structure corresponds to at least half a volume of the fusible material of the fusible element (3).

15. The thermal fuse (1) as claimed in claim 14, characterized in that a base surface (9) of the beaker-shaped structure is larger than a cross-sectional area of the end of the fusible element (3).

16. The thermal fuse (1) as claimed in claim 2, characterized in that the expansion surface (6) corresponds to an internal surface of a funnel-shaped structure.

17. The thermal fuse (1) as claimed in claim 16, characterized in that a tip of the funnel-shaped structure is flattened with a surface which is equal to or smaller than a cross-sectional area of the end of the fusible element (3).

18. The thermal fuse (1) as claimed in claim 2, characterized in that the expansion surface (6) corresponds to an internal surface of a hollow cone structure whose internal diameter at one point is larger than a diameter of the fusible element (3).
